(19) United States
(12) Patent Application Publication
(10) Pub. No.: US 2016/0066368 A1
(43) Pub. Date: Mar. 3, 2016

(54) COOKING DEVICE

(71) Applicant: Miele & Cie. KG, Guetersloh (DE)

(72) Inventors: Carolin Kaudewitz, Rheda-Wiedenbrueck (DE); Ruediger Hoehn, Hiddenhausen (DE); Alexander Schnee, Buende (DE); Christian Schulze, Enger (DE)

(21) Appl. No.: 14/831,916

(22) Filed: Aug. 21, 2015

(30) Foreign Application Priority Data
Aug. 28, 2014 (DE) 10 2014 112 346.8

(51) Int. Cl. H05B 6/64; A47J 27/04

(52) U.S. Cl. CPC H05B 6/6479; A47J 27/04; A47J 2027/043

(57) ABSTRACT

A cooking appliance includes a housing unit, a cooking chamber, a steam generation unit for supplying the cooking chamber with steam, and a removable container unit associated with the steam generation unit. The removable container unit includes a container portion, a holding portion, and an aperture disposed, at least partially, between the container portion and the holding portion. The holding portion has at least one handle. The container portion and the holding portion together have a longitudinal extent that is a multiple of a width of the holding portion. At least the holding portion has a height that is a multiple of a width of the handle. The width of the handle is between 30 mm and 50 mm. At least in portions, a depth of the handle comprises 60% to 75% of the width of the handle.

### CROSS-REFERENCE TO PRIOR APPLICATION

Priority is claimed to German Patent Application No. DE 10 2014 112 346.8, filed on Aug. 28, 2014, the entire disclosure of which is hereby incorporated by reference herein.

### FIELD

The present invention relates to a cooking appliance with at least one housing unit, at least one cooking chamber and at least one steam generation unit. In this case, the steam generation unit is suitable and configured to supply the cooking chamber with steam. Furthermore, at least one removable container unit, which comprises at least one container portion and at least one holding portion, is associated with the steam generation unit. At least one aperture is configured between the container portion and the holding portion, at least in portions, and at least one handle is provided on the holding portion.

### BACKGROUND

Cooking appliances with a steam generator, in particular steam cookers, provide a user with the possibility of preparing the cooking product in a particularly gentle manner by means of steam. A plurality of methods for steam generation has become known to provide steam in the cooking chamber.

During internal steam generation, water is introduced into the cooking chamber and heated on an evaporation surface, generally on the cooking chamber base, and evaporated. External steam generators, on the other hand, produce steam outside the cooking chamber and do not introduce any water, but only steam, into the cooking chamber.

Water has to be fed to the steam generator or the respective evaporation surface depending on need in both types of steam generation. For this purpose, cooking appliances, which comprise a removable water tank for the steam generator, have become known.

Water for steam generation can be stored in a water tank of this type. In this case, a water tank of this type should ideally be able to receive so much water that at least one complete cooking process can be carried out with the stored water quantity. Otherwise, the user would have to refill water during the cooking process, which can impair the operating convenience and, in the worst case, even the efficiency and/or the cooking result.

A water tank of this type has to provide a certain capacity, but should be provided on the cooking appliance in a manner which is as space-saving and inconspicuous as possible. It may therefore occur that the water tank is dimensioned in such a way that it cannot be conveniently and/or safely held by a user or transported to a water source.

### SUMMARY

A cooking appliance includes a housing unit, a cooking chamber, a steam generation unit for supplying the cooking chamber with steam, and a removable container unit associated with the steam generation unit. The removable container unit includes a container portion, a holding portion, and an aperture disposed, at least partially, between the container portion and the holding portion. The holding portion has at least one handle. The container portion and the holding portion together have a longitudinal extent that is a multiple of a width of the holding portion. At least the holding portion has a height that is a multiple of a width of the handle. The width of the handle is between 30 mm and 50 mm. At least in portions, a depth of the handle comprises 60% to 75% of the width of the handle.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a purely schematic front view of a cooking appliance according to the invention;

FIG. 2 shows the cooking appliance according to FIG. 1 without a cooking chamber door;

FIG. 3 is a purely schematic perspective view of a container unit;

FIG. 4 is a purely schematic sectional view through a container unit;

FIG. 5 is a purely schematic side view of a container unit;

FIG. 6 is a purely schematic plan view of a container unit;

FIG. 7 is a purely schematic view of a container unit from the side in the receiving unit of a cooking appliance according to the invention before the removal of the container unit; and

FIG. 8 is the view according to FIG. 7 in the operating position of the container unit.

### DETAILED DESCRIPTION

The cooking appliance according to the invention comprises at least one housing unit and at least one cooking chamber. At least one steam generation unit, which is suitable and configured to supply the cooking chamber with steam, is associated with the cooking chamber. In this case, at least one removable container unit, which has at least one container portion and at least one holding portion, is associated with the steam generation unit. At least one aperture is configured between the container portion and the holding portion, at least in portions, the holding portion comprising a handle, in particular in the region of this aperture. The container portion and the holding portion together have a longitudinal extent, which makes up a multiple of the width of the holding portion. In addition, the holding portion has a height, which is a multiple of the width of the handle. In this case, the width of the handle is between 33 mm and 50 mm and the depth of the handle makes up, at least in portions, 60% to 75% of the width of the handle.

In this case, the width of the handle in particular means the maximum width or extent of the handle, it being possible for the handle to be formed in different ways.

The aperture between the container portion and the holding portion is, in particular, configured as an access or an intermediate space between the handle and the container portion. Thus, a user's hand can reach between the holding portion and the container portion and easily take hold of or clasp the handle of the container unit.

A multiple of the width means, in particular, that the corresponding extents are configured to be at least three times, four times, five times or even greater than the comparative extent. As a result, a container unit is provided in particular, which is particularly narrow, but tall and deep, so the container portion provides a suitable capacity.

In this case, it is particularly preferred for the capacity for water to be evaporated to be at least 1 litre. However, the capacity is particularly preferably 1.3 litres or even 1.5 litres. This ensures that at least one complete steam process can be carried out without water having to be refilled during the cooking process. It is generally preferred for the capacity of the container unit to be adapted to the size of the cooking chamber.

The cooking appliance according to the invention has many advantages. One substantial advantage is that an arrangement of the container unit next to the cooking chamber is made possible by the special configuration of the container unit. This positioning of the container unit is particularly advantageous as the container unit can be arranged in a particularly space-saving manner and can be concealed in a visually appealing manner by the cooking chamber door.

Owing to the special configuration of the handle of the container unit, it is also possible for a user to be able to remove the container unit from the cooking appliance reliably and conveniently, to be able to fill it with water and to be able to place it back in the cooking appliance. This is achieved in that the special dimensioning of the handle provides a particularly ergonomic shape, which allows the container unit to be held safely and comfortably at the same time. This is necessary, in particular, as the container unit is very narrow but also very deep and tall, which makes it necessary to hold the container unit in a particularly reliable manner.

The width of the handle is preferably between 40 mm and 45 mm. Dimensioning of this type has proven to be particularly suitable.

The depth of the handle particularly preferably makes up approximately 65% to 70% of the width of the handle. A dimensioning of this type has also proven to be particularly advantageous. Thus, for example, with a handle width of about 44 mm, a handle depth of between 28.6 mm and 30.8 mm is preferred. A handle dimension is thereby provided that can be comfortably grasped by a user, but also ensures at the same time that the container is held in a very stable and reliable manner.

In expedient developments, the aperture, at least in portions, has a depth of at least 20 mm. In this case, in particular, an intermediate space is provided between the holding portion and container portion of at least 25 mm and particularly preferably of 27 mm. This ensures that even a user with a relatively large hand can easily reach through the aperture between the holding portion and container portion and can grasp the handle.

In advantageous configurations, the handle, at least in portions, has a substantially rounded cross section. In this case, a per se rounded shape or else an angular shape with rounded edges is particularly advantageous.

The handle is preferably substantially curved, at least in portions, at least at the front side. As a result, an over-arching is provided on the front side of the handle, which allows particularly agreeable grasping of the handle.

The rear side is then particularly preferably also or exclusively substantially curved, at least in portions. As a result, an over-arching is provided on the rear side, which contributes to particularly good grasping and holding comfort.

In expedient developments, the front side of the handle adjoins the rear side by way of at least one radius. In this case, the cross section of the handle may, in particular, have a substantially angular basic shape, the transitions or the edges of the handle being rounded. Particularly good carrying and holding comfort is also made possible here, as when clasping the handle with one hand, no edges can cut into the user's hand. This is particularly advantageous as a relatively large capacity, which results in a relatively heavy filled container, is provided by the container unit.

The container unit can preferably be inserted into a corresponding receiving unit next to the cooking chamber. A receiving unit of this type is taken to mean here, in particular, a type of insertion compartment for the container unit, which provides a water storage tank for the steam generation unit. In this case, a receiving unit in particular means a receptacle with a precise fit.

The container unit, in the installed state, preferably terminates substantially flush with at least one front face of the housing unit. Flush is, in particular, to be taken to mean with the surfaces flush, so when the container unit is in the inserted state, a substantially uniform and preferably flush front face is formed on the housing unit. The installed state is to be taken to mean here the operating state, in which the container unit is substantially completely inserted in the cooking appliance, so a corresponding means for removing water from the tank is immersed in this container unit.

In particularly preferred configurations, at least one push-to-open mechanism is associated with the receiving unit. A push-to-open mechanism of this type can either be provided directly on or in the receiving unit or else be arranged on the container unit. On insertion of the container unit into the receiving unit, at least one spring means of the push-to-open mechanism is preloaded, this stored spring force being stored when the container unit is in the inserted state. If the container unit is to be removed again from the cooking appliance, the push-to-open mechanism is triggered again, so the stored spring force is released. As a result, the container unit is pushed out of the cooking appliance or out of the receiving unit at least to such an extent that a user can easily grasp it.

The steam generation unit advantageously comprises at least one removal device, which comprises at least one pivotable tube. This tube, preferably during insertion of the container unit into the receiving unit, is immersed in the container portion, at least in portions. It is particularly preferred here for the tube to automatically be immersed in the container unit during the insertion thereof. In this case, at least one spring means may preferably be associated with the tube, said spring means ensuring, when the container unit is removed from the receiving unit, that the tube also automatically pivots away upwardly again. In particular, it is preferred for the tube to be mounted substantially horizontally in the upper region of the receiving unit when a container unit has been removed. On insertion of the container unit, the tube is automatically immersed in the container unit and is displaced into an approximately vertical position. In this case, the tube, in expedient configurations, is immersed through a cover of the container unit or through an opening in this cover.

At least one microwave unit with at least one high-frequency generator is particularly preferably associated with the cooking chamber. The high-frequency generator is suitable and configured here to introduce high-frequency radiation into the cooking chamber at at least one inlet point. In a configuration of this type, a combined appliance is provided, with which food can be prepared in steam operation, microwave operation or else in combined operation.

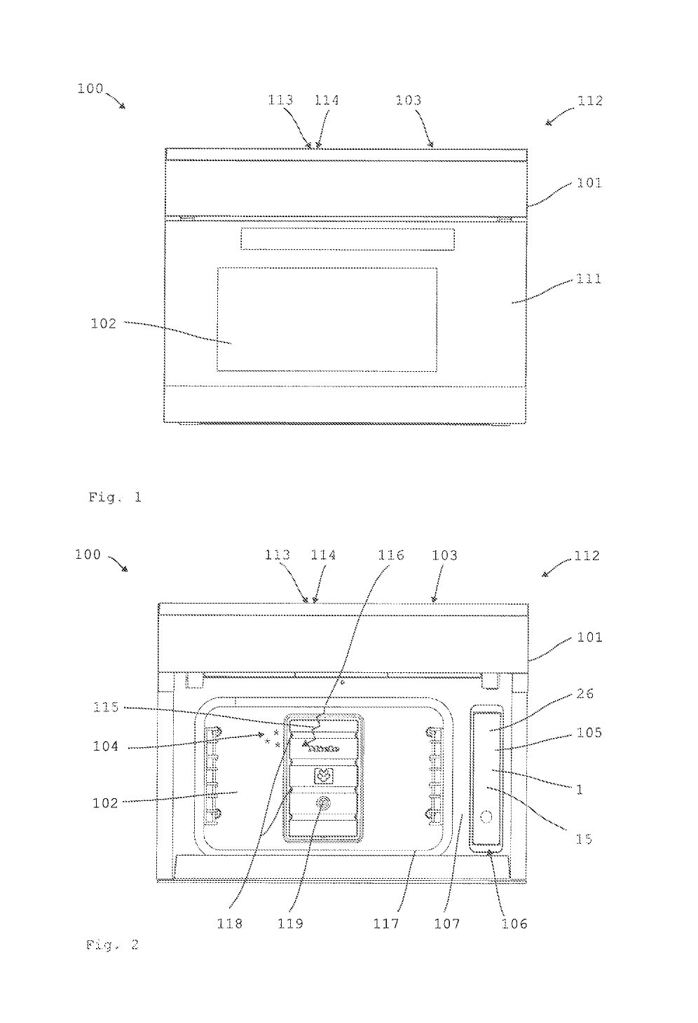

FIG. 1 purely schematically shows a cooking appliance 100 according to the invention in a front view. In this case, the cooking appliance 100 comprises a housing unit 101, in which a cooking chamber 102 is configured. The cooking chamber 102 is closed here by a cooking chamber door 111 in FIG. 1. The cooking appliance 100 further comprises a steam generation unit 103, which is suitable and configured to supply the cooking chamber 102 with steam 104.

The cooking appliance 100 shown is configured here as a combined cooking appliance 112, a microwave unit 113, which comprises a high-frequency generator 114, being additionally associated with the cooking chamber 102 in addition to the steam generation unit 103. In this case, the high-frequency generator 114 is suitable and configured to introduce high-frequency radiation 115 into the cooking chamber 102, at least at one inlet point 116.

FIG. 2 shows the cooking appliance 100 according to FIG. 1, the cooking chamber door 111 not being shown in this view. In this case, the view through the feed opening 117 is into the cooking chamber 102. Various steam inlets 118, by means of which the steam 104 can be guided into the cooking chamber 102, are provided in the cooking chamber 102. In addition, the cooking chamber 102 comprises a steam outlet 119, by means of which excess steam 104 can be removed from the cooking chamber 102.

According to the invention, the steam generation unit 103 of the cooking appliance 100 comprises a water storage means 105 which, in the embodiment shown here, is configured as a container unit 1. The container unit 1 is provided here in a correspondingly configured receiving unit 106 in the housing unit 101 of the cooking appliance 100 next to the cooking chamber 102. In this case, the receiving unit 106 is configured and adapted to the container unit 1 in such a way that the container unit 1 can be substantially completely received in the receiving unit 106.

Thus, the front 26 of the container unit 1, together with the front face 107 of the housing unit 101, forms a substantially flush face. In this case, the container unit 1 and the front face 107 are substantially provided with the surfaces flush. This, in particular prevents a user attempting to reach between the handle 25 and the receiving unit 106 when the container unit 1 is inserted and pulling said container unit out. The container unit 1 should namely be removed by means of a push-to-open mechanism to be described in more detail below.

The arrangement of the container unit 1 next to the cooking chamber 102 is possible owing to the special configuration of the container unit 1. In this case, the container unit 1, owing to the special dimensioning of the container unit 1, can be received next to the cooking chamber 102 without the size of the cooking chamber having to be restricted, or substantially restricted, or else increasing the external dimensions of the cooking appliance, or substantially increasing them. The special dimensioning and configuration of the container unit 1 is shown in more detail in the following figures.

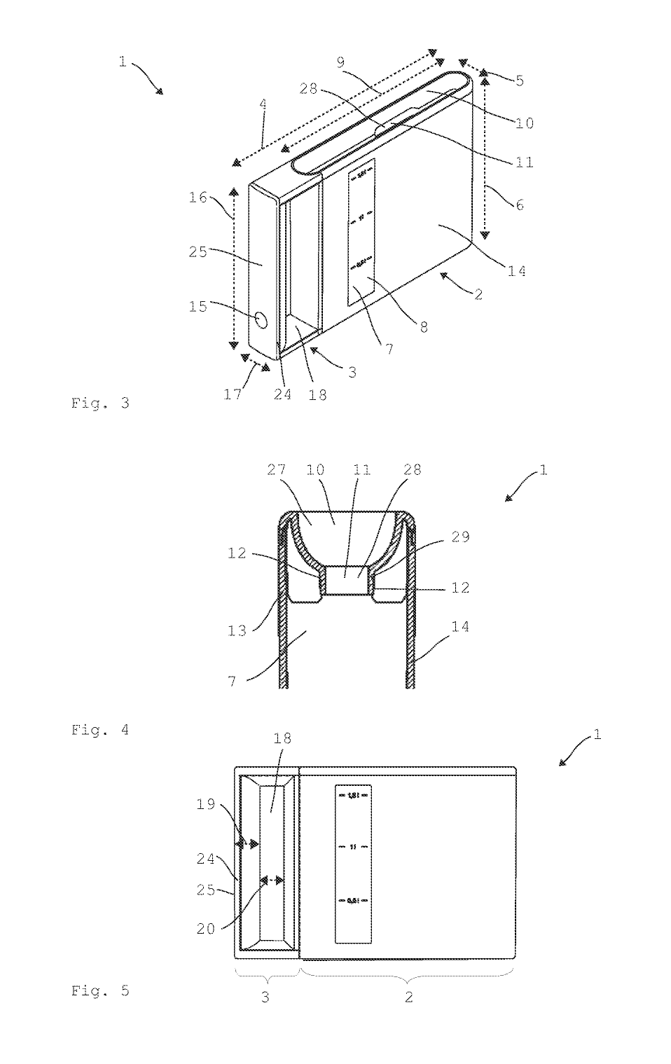

FIG. 3 shows the container unit 1 in a purely schematic perspective view. In this case, the container unit 1 comprises a container portion 2 and a holding portion 3. The container portion 2 provides a capacity 7 for water 8. The holding portion 3 comprises a handle 25, which allows a user to hold the container unit 1 safely and conveniently despite the special dimensions.

The container portion 2 and the holding portion 3 together have a longitudinal extent 4, which makes up a multiple of the width 5 of the container portion 2. In addition, the height 6 of the container portion 2 is greater by a multiple than the width 5 of the container portion 2. In this case, the height 6 of the container portion 2 corresponds to the height 16 of the holding portion 3.

The container unit 1 or the container portion 2 is dimensioned and configured in such a way that the container portion 2 provides a capacity 7 for water 8 that is to be evaporated, which is at least 1 litre. In this case, the capacity 7 for water 8, in the embodiment shown here, is selected to be so great that 1.5 litres can be received.

The capacity 7 is in this case adapted to the size of the cooking chamber 102 and selected such that a complete cooking process can be carried out in the steam operation with one filling of the container unit 1. Thus a user does not have to open the cooking chamber door 111 during a cooking process in order to refill water 8 into the container unit 1. This would restrict the operating convenience of the cooking appliance 100 and additionally impair the effectiveness of the cooking appliance 100, as a not insubstantial proportion of steam 104 would escape from the cooking chamber by opening the cooking chamber door 111.

It can in general be achieved by the container unit 1 that an adequate capacity 7 is provided for water 8 that is to be evaporated, the container unit being provided to be as narrow as possible. It can thus be arranged in a space-saving manner next to the cooking chamber 102. In this case, the width 5 of the container portion 2 is preferably between 3 cm and 5 cm. The width 5 is a good 4 cm in the embodiment shown here.

In order to be able to grasp the container unit 1 easily, an aperture 18 is provided between the holding portion 3 and the container portion 2, a user being able to insert his hand through said aperture. This makes it possible for a user to be able to safely clasp the handle 25 of the holding portion 3. Thus, despite the special dimensioning of the container unit 1, the user can safely and nevertheless conveniently remove the container unit 1 from the cooking appliance 100 and transport it, for example, to a sink.

The embodiment shown of the container unit 1 has a longitudinal extent 4 of the container portion 2 and holding portion 3 of 31.1 cm. In this case, 25.6 cm thereof are allotted to the longitudinal extent 9 of the container portion. The container unit 1 also has a height of 21.2 cm. The width 5 of the container portion 2 corresponds to the width 17 of the holding portion 3, a width of 4.4 cm being selected. In other configurations, other dimensions may expediently also be provided, as are defined inter alia in the claims.

However, it is generally preferred for the container unit 1 to be higher by a multiple and deeper by a multiple than the width of the container unit 1. A multiple is, in particular, to be taken to mean here that the container unit 1 is at least three times, four times, five times or even higher and/or deeper than wide.

A marking 15, which indicates to a user a suitable force point for removing the container unit 1, is provided on the holding portion 3 or on the front 26 of the holding portion 3. As will still be described in FIGS. 7 and 8, a user is assisted in removing the container unit 1 from the removal device 106 by a push-to-open mechanism 108.

The container unit 1 in addition, in the embodiment shown here, comprises a cover 10. This cover 10 is configured as a lid 27, which has at least one opening 11 in this configuration.

A purely schematic sectional view through a container unit 1 is shown in more detail in FIG. 4. It can be seen here that the cover 10 is configured in such a way that it can be placed on the container portion 2. In this case, the cover 10 encompasses the two walls 13 and 14 of the container unit 1, at least in portions.

As a result, an additional stabilisation of the container portion 2 is made possible, as the cover 10 fixes the two walls 13 and 14 in a specific position in relation to one another. Thus, it is also possible, in particular, for the thickness of the walls 13, 14 to be made very small, without of the container unit 1 becoming unstable.

The opening 11 in the cover 10 is used, in particular, to fill the container portion 2 with water 8. In this case, for example, water 8 can be refilled into the container portion 2 from a water tap via this opening 11. In addition, a tube 110 can be pivoted through this opening 11 into the container portion 2. Water 8 can also be removed from the receiving portion 2 by this tube 110 in order to feed the water to the steam generation unit 103 for evaporation. For this purpose, the opening 11 in the cover 10 is, in particular, elongate and is provided here by a slot 28.

So that no water 8 can be spilt during transportation of the filled container unit 1 from a water source to the cooking appliance 100, a protective device 12 is associated with the container portion 2. In this case, the protective device 12 is provided on the cover 10 in the embodiment shown here. In this case, the cover 10 is shaped in such a way that the protective means 12 forms a type of collar 29, which extends, at least in portions, inwardly into the container portion 2. This collar 29 effectively prevents water 8 from being able to slosh out of the opening 11 during transportation of the container unit 1.

In other advantageous configurations, the protective means 12 can also be provided on the container portion 2 and, in particular, be configured thereon.

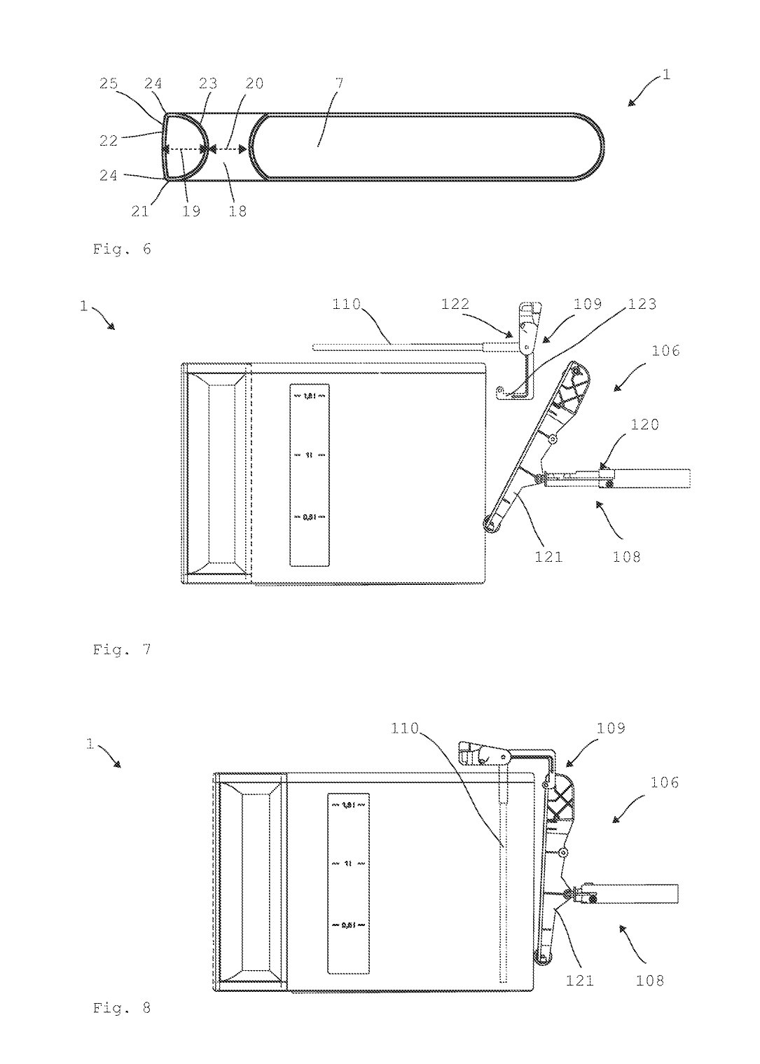

So that a user can grasp the container unit 1 safely and conveniently, a special dimensioning of the holding portion 3 or the handle 25 is also provided. The special dimensioning will be described in more detail with the aid of FIGS. 5 and 6 below.

In this case, the width 17 of the handle 25 is between 30 and 50 mm, the depth 19 of the handle 25 making up between 60% and 75% of the width 17 of a handle 25, at least in portions. With a dimensioning of this type of the handle 25, the ratio between the width 17 and depth 19 of the handle 25 is advantageously selected in such a way that a user can hold the container unit 1 safely, reliably and also conveniently, despite the great height and depth of the container unit 1.

So that a user can also easily reach and clasp the handle 25, the aperture 18 between the container portion 2 and holding portion 3 has to have a corresponding size. In this case, the aperture 18 is advantageously configured in such a way that the depth of the aperture 20 is at least 20 mm, at least in the region of the handle 25. In the embodiment shown here, the depth of the aperture 20 has been adjusted to 27 mm, so even a user with relatively large hands can reach through the aperture 18 without problems and can clasp the handle 25.

FIG. 6 purely schematically shows a sectional plan view of the container unit 1. It can be seen in this view that the holding portion 3 or the handle 25 has a rounded cross section 21. This is achieved in the embodiment shown in that the handle 25 is substantially curved on the front side 22 and on the rear side 23.

Particularly convenient clasping of the handle 25 is made possible by the over-archings on the front side 22 and on the rear side 23. So that the user can clasp the handle 25 particularly conveniently, the edges of the handle 25 are configured in such a way that the front side 22 and the rear side 23 adjoin one another in each case by way of at least one radius 24. This avoids the handle 25 having edges, which could cut into the hand of a user.

Owing to the general rounded configuration of the handle 5 and, in particular, also owing to the radii 24 between the front side 22 and the rear side 23, a particularly ergonomically shaped handle 25 is provided.

FIGS. 7 and 8 show purely schematically that a push-to-open mechanism 108 is associated with the receiving unit 106 of the cooking appliance 100. The drawings show purely schematically a side view of the container unit 1 in the receiving unit 106.

In this case, the push-to-open mechanism 108 is configured in the receiving unit 106 in the embodiment shown here and assists the user when removing the container unit 1 from the cooking appliance 100. In other configurations, the push-to-open mechanism 108 may, however, also be provided on the container unit 1.

FIGS. 7 and 8 show purely schematically that a spring means 120 of the push-to-open mechanism 108 is preloaded when the container unit 1 is inserted into the receiving unit 106 and is kept in this preloading. In this situation, the container unit 1 is substantially completely inserted into the receiving unit 106 and, together with the front face 107 of the housing unit 101, forms a flush face.

In order to remove the container unit 1 from the receiving unit 106 again, the container unit 101 is pushed a small way into the receiving unit, so the push-to-open mechanism 108 is triggered and the stored spring force pushes a displacement element 121 forward. This displacement element 121 then pushes the container unit 1 so far out of the receiving unit 106 that a user can reach through the aperture 18 between the container portion 2 and holding portion 3 and can take hold of the handle 25. A suitable force point to trigger the push-to-open mechanism is indicated to the user by a marking 15 on the front 26 of the holding portion 3.

It can also be seen in FIGS. 7 and 8 that a removal device 109, by means of which water 8 can be removed from the receiving portion 2 and fed to the steam generation unit 103, is associated with the receiving unit 106.

In this case, the removal device 109 comprises a tube 110, which, when the container unit 1 is not inserted, is kept in an approximately horizontal position by a spring means 122. If the container unit 1 is inserted into the receiving unit 106, it comes into contact with the displacement element 121 of the push-to-open mechanism 108 and presses this displacement element 121 back. As a result, the spring means 120 of the push-to-open mechanism 108 is tensioned.

At the same time, the tube 110 is automatically immersed in the container portion 2 through the opening 11 in the cover 10 of the container unit 1. This takes place in that the container unit 1 presses against a leg 123 of the removal device 109 and therefore allows it to be immersed in the container portion 2 against the spring force of the spring means 122.

If the push-to-open mechanism 108 is unlocked again, the container unit 1 is pushed out of the receiving unit 106 by the spring force of the spring means 120. As a result, the tube 110 is automatically simultaneously pivoted away upwardly again by the spring means 122 of the removal device 109, so the container unit 1 can be removed from the cooking appliance 100 without problems.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 container unit

2 container portion

3 holding portion

4 longitudinal extent

5 width container portion

6 height container portion

7 capacity

8 water

9 longitudinal extent

10 cover

11 opening

12 protective device

13 wall

14 wall

15 marking

16 height holding portion

17 width handle

18 aperture

19 depth handle

20 depth aperture

21 cross section

22 front side

23 rear side

24 radius

25 handle

26 front

27 lid

28 slot

29 collar

100 cooking appliance

101 housing unit

102 cooking chamber

103 steam generation unit

104 steam

105 water storage means

106 receiving unit

107 front face

108 push-to-open mechanism

109 removal device

110 tube

111 cooking chamber door

112 combined cooking appliance

113 microwave unit

114 high-frequency generator

115 high-frequency radiation

116 inlet point

117 feed opening

118 steam inlet

119 steam outlet

120 spring means

121 displacement element

122 spring means

123 leg

What is claimed is:

1. A cooking appliance comprising:
at least one housing unit;
at least one cooking chamber;
at least one steam generation unit configured to supply the at least one cooking chamber with steam; and
at least one removable container unit that is associated with the at least one steam generation unit and comprises at least one container portion, at least one holding portion, and at least one aperture disposed, at least partially, between the at least one container portion and the at least one holding portion,
wherein the at least one holding portion comprises at least one handle,
wherein the at least one container portion and the at least one holding portion together have a longitudinal extent that is a multiple of a width of the at least one holding portion,
wherein at least the at least one holding portion has a height that is a multiple of a width of the at least one handle,
wherein the width of the at least one handle is between 30 mm and 50 mm, and
wherein, at least in portions, a depth of the at least one handle comprises 60% to 75% of the width of the at least one handle.

2. The cooking appliance of claim 1, wherein the width of the at least one handle is between 40 mm and 45 mm.

3. The cooking appliance of claim 2, wherein the depth of the at least one handle comprises 65% to 70% of the width of the at least one handle.

4. The cooking appliance of claim 1, wherein, at least in portions, the at least one aperture has a depth of at least 20 mm.

5. The cooking appliance of claim 1, wherein, at least in portions, the at least one handle has a substantially rounded cross section.

6. The cooking appliance of claim 1, wherein, at least in portions, the at least one handle is substantially curved on a front side.

7. The cooking appliance of claim 1, wherein, at least in portions, the at least one handle is substantially curved on a rear side.

8. The cooking appliance of claim 1, wherein at least one radius adjoins a front side of the at least one handle to a rear side of the at least one handle.

9. The cooking appliance of claim 1, wherein the at least one removable container unit is configured to be inserted into a corresponding receiving unit next to the at least one cooking chamber.

10. The cooking appliance of claim 1, wherein the at least one removable container unit, in the installed state, terminates substantially flush with at least one front face of the at least one housing unit.

11. The cooking appliance of claim 9, wherein at least one push-to-open mechanism is associated with the corresponding receiving unit.

12. The cooking appliance of claim 1, wherein the at least one steam generation unit comprises at least one removal device.

13. The cooking appliance of claim 12, wherein the at least one removal device comprises at least one pivotable tube.

14. The cooking appliance of claim 13, wherein, at least in portions, the at least one pivotable tube is configured to be immersed in the at least one container portion when the at least one removable container unit is inserted into the receiving unit.

15. The cooking appliance of claim 1, wherein at least one microwave unit with at least one high-frequency generator is associated with the at least one cooking chamber.

16. The cooking appliance of claim 15, wherein the at least one high-frequency generator is configured to introduce high-frequency radiation into the at least one cooking chamber at at least one inlet point.
